(19) United States
(12) Patent Application Publication
(10) Pub. No.: US 2002/0089897 A1
(43) Pub. Date: Jul. 11, 2002

(54) Facilitated setting/resetting of digital date displays

(76) Inventor: Berj A. Terzian, Newbury, MA (US)

Correspondence Address: David L. Just, Lucas & Just, 60 East 42nd Street, New York, NY, 10165, US

(21) Appl. No.: 09/755,486

(22) Filed: Jan. 5, 2001

(51) Int. Cl. G04B 19/24; G04C 17/00

(52) U.S. Cl. 368/29

(57) ABSTRACT

Setting or resetting of digital dates in digital time displays is facilitated by providing an array of display elements which can be selectively activated to display the capital letters M, D and Y, together with simultaneously displayed digital values of months, days and years, respectively. This enables setting or resetting a digital time display to the corresponding correct current month, day and year, without confusion, uncertainty or ambiguity, even if identical, repeated date values are displayed during the setting or resetting process.

### BACKGROUND OF THE INVENTION

I. Field of the Invention

This invention relates to the setting or resetting of digital dates for months, days and years in digital time displays.

II. Description of the Prior Art

Digital wristwatches and other digital timepieces frequently include a display of the numerical date for each day of the month, often with an abbreviated name of each day as well. When power is interrupted to such displays, such as replacement of a depleted watch battery, or outages of line power, or cleaning or repair operations, many such displays revert to a default condition of all zeros, or to the month, day and year date when the calendar software was originally programmed into the timepiece. Therefore, after such interruptions, all dates have to be reset to the digital values of the prevailing month, day and year in order to synchronize the display with the current time.

In some products, particularly wristwatches, digital values of each month, day and year are displayed in the setting/resetting mode with a pair of digits which scroll through ranges of one through twelve for the months and one through thirty-one for the days, with or without non-significant zero digits in front of single digital values representing the first nine months and the first nine days, respectively. Similar scrolling through pairs of digits is used to display the values of years, beginning, for example, with 00 for the year 2000 and continuing up to 99 for the year 2099, given the recent advent of the second millennium.

III Recognition of Problems in the Prior Art

The above-described scrolling systems are subject to problems caused by the redundancy and repetition of identical digital values. For example, Jan. 1, 2001 conceivably could be represented by three repetitions of the value 01, thus requiring the user typically to remember the scrolling sequence, for example, first the month, then the day and finally the year, as is usually explained in the operating instructions, in order to understand what the displayed digital value represents. Similar redundancies are encountered between pairs of identical digital values representing months and days, months and years, and days and years. These problems are exacerbated by the fact that in some parts of the world, other scrolling sequences are used, such as the year, month and day, or the day, month and year. Therefore, there is a need for overcoming the above-described problems in order to facilitate and increase certainty in the setting or resetting of digital date displays.

### SUMMARY OF THE INVENTION

The present invention provides a simple and effective solution to the above-described problems, achieved by a novel array of display elements that can be selectively activated to display the letters “M”, “D” and “Y”, standing for month, day and year, when each of such digital dates is being set or reset in a digital time display. As a result, the viewer is unambiguously informed of which specie of time value is being set or reset, even if identical digital values are displayed during the setting or resetting sequence. This eliminates the need to remember what particular sequence of values is presented by any specific timepiece during the setting/resetting mode, and enables the setting or resetting process to be confidently performed without any confusion, uncertainty or ambiguity.

### BRIEF DESCRIPTION OF THE DRAWINGS

FIG. 1 illustrates a preferred embodiment of digital display elements arrayed in a manner which enables setting or resetting digital date values in accordance with the present invention.

FIG. 2 is a similar view which illustrates activation of the FIG. 1 array to enable setting the date of a current month.

FIG. 3 is a similar view which illustrates activation of FIG. 1 to enable setting the date of a current day.

FIG. 4 is a similar view which illustrates activation of FIG. 1 to enable setting the date of a current year.

### DESCRIPTION OF THE PREFERRED EMBODIMENT

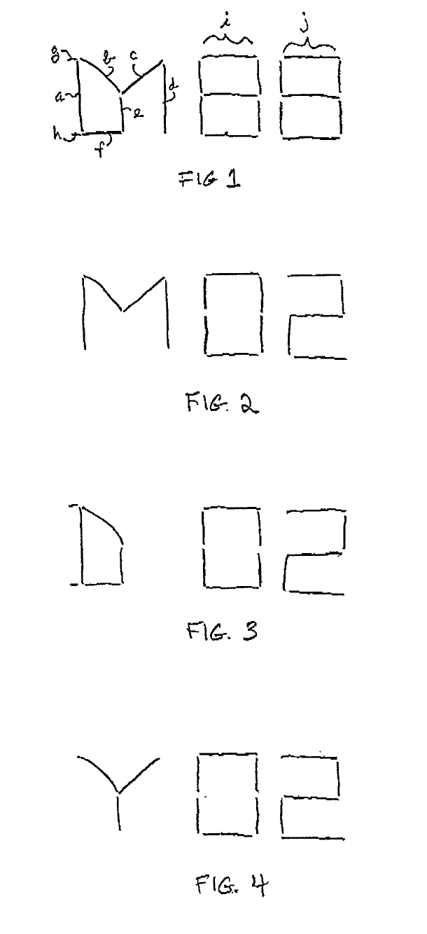

Referring again to FIG. 1, it illustrates three sets of digital display elements which can be selectively activated, electronically or electrically, to become visible in a digital time display, e.g. LCD, LED, fluorescent, incandescent or gaseous glow displays. The first array, at the left, comprises eight elements referenced by the lead lines labeled as “a”-“h” inclusive. Elements a, b, c and d can be activated to display a capital M, with elements b and c providing the internal V-shaped segment, and elements a and d the vertical outer segments, of that letter. The left element b of the b/c pair is preferably curved convexly upwardly for reasons explained below.

Elements b, e, f, g and h can be activated to display a capital letter D. Elements b, e, f and g form the closed perimeter, and elements g and h provide small leftward horizontal extensions of the top and the bottom, of that letter.

Elements b, c and e can be activated to display a capital letter Y, with elements b and c again providing the upper V-shaped segment, and element e the lower vertical base, of that letter.

Finally, there is a pair of 7-segmented digital display elements to the right of array a-h, referenced as composites by the brackets labeled as “i” and “j”, respectively. Each of these 7-segmented arrays can be activated to display digital values from zero to nine in conventional manner.

Referring now to FIG. 2, illustrated there is a selective activation of the arrays of FIG. 1 to display “M 02,” which represents the fact that the display is synchronized with the second of the twelve months, i.e. February. Similarly, scrolling through all of the digital values of the twelve months, with the capital letter M remaining visible throughout the entire sequence, will inform the viewer that all such values are being presented for selection and setting or resetting to the appropriate month.

Next, FIG. 3 illustrates a selective activation of the FIG. 1 arrays to display “D 02,” which represents the fact that the display is synchronized to the second day of the month. Here, the preferred curved shape of the element b, together with the horizontal extension elements g and h, assist the viewer to recognize that the resulting letter is a somewhat stylized capital letter D, standing for the day. Again, scrolling through all the values of the thirty one days, with the letter D remaining visible, will unambiguously inform the viewer that all such values are available for selection and setting or resetting to the appropriate day date.

Finally, referring to FIG. 4, illustrated there is selective activation of the FIG. 1 array to display “Y 02,” which represents the fact that the display is synchronized to the second year of second millennium, i.e. the year 2002. Depending on how far into the future the calendar software program is projected, scrolling through the sequence of all such values, again with the letter Y remaining visible, enables the viewer to readily select and set or reset the display to the applicable current year date. Thus, at the end of the process of setting or resetting the FIG. 1 array, in the exemplary manner of FIGS. 2-4, the viewer can confidently conclude that the process has been correctly and accurately performed no matter how many repeated identical digital values have been seen.

The invention has now been described in terms of its operating principles and a specific preferred embodiment. Many variations or modifications of the preferred embodiment will be evident to those skilled in the art. For example, the curvature of element b in FIG. 1 can be increased or decreased to suit individual preferences. Element c can be shaped in the straight linear manner shown in FIGS. 1 and 4 or it can be curved in analogous manner to element b, if desired. Alternatively, both elements b and c can be maintained as straight linear elements, although this may detract from recognition of the resulting letter in FIG. 3 as a capital D. Likewise, horizontal extensions g and h can be eliminated for the sake of fewer elements, but again at the risk of diminishing recognition of capital letter D in FIG. 3.

While the preferred embodiment is based upon the usual American sequence of setting the month, day and year in that order, other sequences practiced in Europe or elsewhere, such as the year, month and day, or the converse, day, month and year, can be equally enhanced by implementing the principles of the invention therein. Also, if a digital display is conventionally programmed to unambiguously display the year with all four digits, then the invention can be adopted to eliminate confusion or uncertainty between month and day date values displayed with only a pair of digits, as illustrated in FIGS. 1-3.

Furthermore, while the invention had been described with respect to the English initials M, D, Y, it is within the contemplation of the invention to use it with other languages, such as German, where Monat (month) is still M, but Tag (Day) becomes T and Jahre (year) becomes J. This will require rearrangement of the elements of FIG. 1, but such is certainly well within the skill of the art.

The invention can be incorporated in any digital timepiece which requires resynchronization of calendar digital dates, i.e. months, days and/or years, to the present time, whenever its operation is interrupted or otherwise disrupted out of synchronization. The invention is especially useful in combination with enhanced quadribalanced digital time displays described in allowed application Serial No. 09/619,368, filed Jul. 19, 2000, and with a single crown control for setting/resetting those displays, described in application Serial No.09/679,864, filed Oct. 5, 2000.

In closing, it should be understood that the following claims are intended to cover all changes and modifications of the illustrative embodiments which fall within the literal scope of the claims and all equivalents thereof.

The following is claimed:

1. An array of display elements for facilitating the setting or resetting of digital dates comprising:
means for displaying a capital letter M during the setting or resetting of a digital time display to the digital value of the current month, and
means for displaying a capital letter D during the setting or resetting of the digital time display to the digital value of the current day.

2. An array according to claim 1 which further comprises means for displaying a capital letter Y during the setting or resetting of the digital time display to the digital value of the current year.

3. An array according to claim 1 in which the digital values of months and days are each a pair of 7-segmented digital display elements.

4. An array according to claim 2 in which the digital values of months, days and years are each a pair of 7-segmented digital display elements.

5. An array according to claim I which further comprises display means that are electronically or electrically activatable.

6. An array of display elements for facilitating the setting or resetting of digital dates comprising:
a. two elements forming a V-shape pointed downwardly;
b. three elements extended downwardly from the upper ends and the vertex of the V-shaped elements; and
c. one element extended horizontally between the lower ends of the two elements extended downwardly from, respectively, the left member and the vertex of the V-shaped elements; whereby the V-shaped elements and the two elements extended downwardly from the upper ends of the V-shaped elements may be selectively activated to display a capital letter M during setting or resetting of a digital time display to the current month, and
the left member of the V-shaped elements, the element extended downwardly from the upper end thereof, the element extended downwardly from the vertex of the V-shaped elements, and the element extended horizontally between the lower ends thereof may be selectively activated to display a capital letter D during setting or resetting of the digital time display to the current day, and
the V-shaped elements and the element extended downwardly from the vertex thereof may be selectively activated to display a capital letter Y during the setting or resetting of the digital time display to the current year.

7. An array according to claim 6 in which the left member of the V-shaped elements is curved convexly upwardly to enhance recognition of the activated capital letter D.

8. An array according to claim 6 which further comprises two relatively short additional elements extended leftward from the upper end of the left member of the V-shaped elements and from the bottom end of the element extended downwardly from the upper end of the left member of the V-shaped elements, which additional elements may be selectively activated to enhance recognition of the activated capital letter D.

9. An array according to claim 6 in which the activated capital letters M, D and Y are displayed simultaneously with digital values of months, days and years, respectively, to enable setting or resetting the digital time display to the correct current month, day and year.

10. An array according to claim 9 wherein the digital values of months, days and years are each a pair of 7-segmented digital display elements.

11. An array of display elements for setting or resetting digital dates comprising:
means for displaying a letter which is the first letter of the word month in a selected language during the setting or resetting of a digital time display to the digital value of the current month;
means for displaying a letter which is the first letter of the word day in the selected language during the setting or resetting of a digital time display to the digital value of the current day;
means for displaying a letter which is the first letter of the word year in the selected language during the setting or resetting of a digital time display to the digital value of the current year.

12. A method of facilitating the setting or resetting of digital dates comprising:
providing elements for, and displaying, a capital letter M during the setting or resetting of a digital time display to the digital value of the current month, and
providing elements for, and displaying, a capital letter D during the setting or resetting of the digital time display to the digital value of the current day.

13. A method according to claim 12 which further comprises providing elements for, and displaying, a capital letter Y during the setting or resetting of the digital time display to the digital value of the current year.

14. A method according to claim 12 which further comprises displaying the digital values of each of months and days with a pair of 7-segmented digital display elements.

15. A method according to claim 13 which further comprises displaying the digital values of each of months, days and years with a pair of 7-segmented digital display elements.

16. A method of facilitating the setting or resetting of digital dates comprising:
providing an array of display elements comprising
a. two elements formed in a V-shape pointed downwardly;
b. three elements extended downwardly from the upper ends and the vertex of the V-shaped elements;
c. one element extended horizontally between the lower ends of the two elements extended downwardly from, respectively, the left member and the vertex of the V-shaped elements, and
selectively activating the V-shaped elements and the two elements extended downwardly from the upper ends of the V-shaped elements to display a capital letter M during setting or resetting of a digital time display to the current month, and
selectively activating the left member of the V-shaped elements, the element extended downwardly from the upper end thereof, the element extended downwardly from the vertex of the V-shaped elements, and the element extended horizontally between the lower ends thereof, to display a capital letter D during setting or resetting of the digital time display to the current day, and
selectively activating the V-shaped elements and the element extended downwardly from the vertex thereof to display a capital letter Y during setting or resetting of the digital time display to the current year.

17. A method according to claim 16 further comprising forming the left member of the V-shaped elements in a curve disposed convexly upwardly and activating the curved element to enhance recognition of the activated capital letter D.

18. A method according to claim 16 further comprising providing two relatively short additional elements extended leftward from the upper end of the left member of the V-shaped elements and from the bottom end of the element extended downwardly from the upper end of the left member of the V-shaped elements, and activating such additional elements to enhance recognition of the activated capital letter D.

19. A method according to claim 16 which further comprises displaying the digital values of each of months, days and years with a pair of 7-segmented digital display elements.
